(19) United States
(12) Patent Application Publication
(10) Pub. No.: US 2026/0194623 A1
(43) Pub. Date: Jul. 9, 2026

(54) METHOD OF JOINT COMMUNICATION AND ENVIRONMENT PERCEPTION

(71) Applicant: Continental Automotive Technologies GmbH, Hannover (DE)

(72) Inventors: David Gonzalez Gonzalez, Egelsbach (DE); Osvaldo Gonsa, Frankfurt (DE); Hyeon Seok Rou, Bremen (DE); Giuseppe Thadeu Freitas de Abreu, Bremen (DE)

(73) Assignee: Continental Automotive Technologies GmbH, Hannover (DE)

(21) Appl. No.: 19/132,889

(22) PCT Filed: Nov. 20, 2023
(86) PCT No.: PCT/EP2023/082332

§ 371 Date: May 27, 2025

(30) Foreign Application Priority Data
Nov. 25, 2022 (DE) 10 2022 212 615.7

(51) Int. Cl. G01S 7/00; G01S 13/931; H04B 7/08; H04L 25/02

(52) U.S. Cl. CPC G01S 7/006; G01S 13/931; H04B 7/0854; H04L 25/0224

(57) ABSTRACT

Wireless communication signals, represented by voxels arranged in a three-dimensional grid, are processed. An environment of interest includes ≥1 access points and ≥1 UEs. Each of the access points has ≥1 antennas. Processing includes receiving a plurality of transmit symbols, including pilot signals and data signals, sent by all of the UEs, and iteratively, for each of the antennas of each of the access points and for all voxels in the region of interest and for all transmit symbols, performing a soft interference cancellation to received communication signals, determining soft-replicas and corresponding MSEs, and updating all soft-replicas and corresponding MSEs, while a termination criterion is not fulfilled. Next, for each voxel in the region of interest, and for each transmit symbol, a respective final soft-estimate is computed, from the corresponding soft-replicas, which is projected to the symbol constellation and output as hard estimate.

### CROSS-REFERENCE TO RELATED APPLICATIONS

The present application is a National Stage Application under 35 U.S.C. § 371 of International Patent Application No. PCT/EP2023/082332 filed on Nov. 20, 2023, and claims priority from German Patent Application No. 10 2022 212 615.7 filed on Nov. 25, 2022, in the German Patent and Trademark Office, the disclosures of which are herein incorporated by reference in their entireties.

### FIELD OF THE INVENTION

The invention relates to the field of environment sensing or environment mapping, in particular to such sensing using wireless communication signals. More specifically, the invention relates to a method of processing communication signals for environment perception, to a computer program product implementing the method, to a computer-readable storage medium storing the computer program product, to a receiver configured to execute the method, to a system including such receiver, and to a mobile entity comprising such receiver, e.g., a vehicle. Throughout this specification the term environment sensing will be used for the various expressions widely used for capturing information about an environment for creating a three-dimensional representation thereof.

### Notations

Scalar values are denoted herein by lowercase letters in italics, as in x, while complex vectors and matrices are denoted by boldface lowercase and uppercase letters, as in x and X, respectively. (⋅)^{T} and (⋅)* denote the transposition and complex conjugation operators respectively, and diag(⋅) and exp[⋅] denote the diagonalization and exponentiation operators, respectively. |⋅| denotes the absolute value operator whereas the ∥ ∥ [symbol] denotes the [symbol] -th norm. [symbol] ₓ(x) and Varₓ(x) respectively denote the expectation and variance operator of x with respect to the distribution of x given by [symbol] ₓ(x). [symbol] and [symbol] denote the real and complex number fields respectively, and N(μ, v) and CN(μ, v) denotes the real and complex Gaussian distributions with mean y and variance v.

### BACKGROUND

Joint Communication and Sensing (JCAS) is a technique in wireless communications with the objective of retrieving information about the environment from the signal scattering which is present in the effective channel state information (CSI), e.g., due to objects in the environment, blockage, user activity, etc., while simultaneously achieving data communication. Most known JCAS methods exploit radar technology to infer information about the environment. This is also known as joint radar and communication (JRC).

Various methods are known in JRC, including alternating or sharing spectrum between radar and communication signals, using standard radar signals to embed information, extracting radar parameters from standard communication signals, or even designing new waveforms suited for both tasks. These techniques are highly based on conventional radar signal processing (e.g., ambiguity function estimation) and dependent on the radar frequency-delay properties and prone to similar challenges.

In robotics vision and mapping, for systemizing the collection of environment information, e.g., as in the exemplary environment shown in FIG. 1a), 3D voxelated occupancy grids were introduced, where the total region of interest (ROI) is defined as a cuboidal space of dimensions Lₓ′L_{y}′L_{z}, each denoting the lengths of the x, y, z-axes in meters, respectively. The entire ROI is subdivided into a grid consisting of N_{V}≅Nₓ·N_{y}·N_{z} voxels, where

$${N}_{x} {=}^{Δ} \frac{{L}_{x}}{{L}_{V}} , {N}_{y} {=}^{Δ} \frac{{L}_{y}}{{L}_{V}} , and {N}_{z} {=}^{Δ} \frac{{L}_{z}}{{L}_{V}}$$

denote the number of voxels per x, y, z-axes, respectively, and L_{V} is the edge length of a voxel cube in meters. If represented as a tensor of three dimensions (Nₓ′N_{y}′N_{z}), the voxelated occupancy grid directly represents a discretized model of the ROI as shown in FIG. 1b) and c), where the size of the voxels corresponds to the image resolution. In addition to the 3D geometric information as provided by the classic voxelated occupancy grid, the electromagnetic scattering behaviour of the true environment may also be incorporated to tailor the modelling method to be utilized in a wireless communication scenario.

To that end, first consider each voxel to be represented by a voxel occupancy coefficient \hat{v}ₖ ∈{0, 1} with k∈{1, . . . , N_{V}}, where \hat{v}ₖ=0 indicates that the k-th voxel is empty, i.e., the corresponding environment is free-space, and \hat{v}ₖ=1 indicates that the k-th voxel is occupied by a scatterer object, e.g., the table, chair or the object on the wall, as illustrated in FIG. 1. Note that the binary voxel occupancy coefficients may be extended to complex voxel scattering coefficients, i.e., \hat{v}ₖ≅βₖ·e^{-jω}^{ₖ} ∈ [symbol] to also capture the effect incurred to the reflected electromagnetic waves by the occupied voxels. The values of the voxel scattering coefficients are expected to be highly dependent on the electromagnetic characteristics of the scatterer object and the impinging wave, which may be empirically measured and modelled as a function of the properties such as frequency and material. However, such extension and specific modelling is out of scope of the present specification.

The voxelated environment first introduced in robotics vision and mapping may be exploited for devising methods of joint communication and environment detection, which operate without the usage of radar properties, i.e., mainly relying on pure communication signals.

For example, in “Joint Multi-User Communication and Sensing Exploiting Both Signal and Environment Sparsity,” IEEE Journal of Selected Topics in Signal Processing, vol. 15, no. 6, pp. 1409-1422, Nov. 2021, X. Tong, Z. Zhang, J. Wang, C. Huang and M. Debbah consider a regular voxelated 3D space with some scatterer objects accommodating a single access point (AP), a single reconfigurable intelligent surface (RIS), and multiple single-antenna user equipment (UEs). The multiple UEs are communicating to the AP via sparse code multiple access (SCMA) over multiple frequency subcarriers and over multiple transmission instances, via line-of-sight (LOS) paths and non-line-of-sight (NLOS) paths from the UEs, to the scatters, to the RIS, then finally to the AP.

A general concept of LOS and NLOS paths in a voxelated space is shown in FIG. 2. The LOS path is the direct path between the UE and the AP, while the two occupied voxels in the ROI reflect signals emitted by the UE towards the AP. The dashed lines represent the NLOS UE-to-voxel path, and the dotted lines represent the NLOS voxel-to-AP path. FIG. 3 shows a schematic representation of the 3D space considered in the known system and method, including the RIS. Here, the signal reflected off the RIS towards the AP is shown in a dash-dotted line, to highlight its specific origin.

According to the known system model and assumptions, the signals received at the AP would not only carry users' payload, or data, but also contain the scattered path information which can be used to retrieve, or perceive, the environment. To aid the estimation, UEs are assumed to transmit a known length of pilot symbols at the beginning of the transmission interval, i.e., a known preamble. The known algorithm aims to return the estimates of the transmitted SCMA codes of the UEs, i.e., user detection, or identification, and a binary voxel occupancy grid which corresponds to the estimation of the environment, e.g., 0 for a voxel representing empty space and 1 for a voxel representing an occupied space.

The known system may be represented mathematically by the following model

$$Y = ( H + PRQVB ) [ {X}_{p} X ] + W$$

where Y is the received signal matrix over all receive antennas and APs across all symbol instances, H is the UE-to-AP LOS channel matrix, P is the RIS-to-AP NLOS channel matrix, R is the RIS reflection coefficient matrix, Q is the voxel-to-RIS NLOS channel matrix, B is the UE-to-voxel NLOS channel matrix, V is the voxel occupancy matrix, Xₚ is the pilot symbol matrix, X is the data symbol matrix, and W is the AWGN noise matrix. To simplify, since the matrices P, R, Q, and B are known, the model can be simplified as

$$Y = ( H + AVB ) [ {X}_{p} X ] + W$$

where A=PRQ is the effective voxel-to-AP NLOS channel matrix.

From this, the main joint communication and sensing problem is formulated, i.e., to estimate the environment matrix V and data symbol matrix X, with known channel matrices H, A, B, and known pilot matrix Xₚ.

To do so the prior art method uses three modules:
an environment estimation module, using a linear generalized approximate message passing (GAMP) algorithm which uses the known channels, with given data symbols X, either pilots or estimated symbols from a previous iteration, for estimating the environment V, on the model

$$Y = ( H + AVB ) [ X ] + W$$

an effective channel reconstruction module which, by integrating known channels and the estimated environment and using V estimated by the GAMP algorithm, combines the information with known H, A, B to calculate the effective total channel

$$\tilde{H} = H + AVB$$

a data signal estimation module which, using a linear SCMA message passing algorithm (MPA) and the estimated effective channel, estimates the unknown data symbols X,

$$Y = \tilde{H} X + W$$

These three modules are iterated in a sliding window fashion on the time domain as illustrated in FIG. 4, such that first, the environment estimation is carried out using the known pilot symbols, but for the data signal estimation, the window slides for estimating the unknown data symbols, and so on.

The prior art method relies in the assumptions that the channel gains for UEs-to-AP LOS paths are known, that the channel gains for the UEs-to-voxels, voxels-to-RIS, RIS-to-AP NLOS paths are known, that the RIS reflection coefficients are known, that the voxelated environment model is binary, i.e., only discrete occupancy values 0 or 1 are possible, that an SCMA communication scheme is used, and that only a single AP is present. These assumptions pose severe limitations to applying the known method to actual 3D real-world environments, giving rise to the need for an improved method of processing wireless communication signals for use in environment sensing, a receiver configured to execute the improved method, and a communication system comprising one or more such receivers.

### BRIEF SUMMARY

This need is addressed by the method, computer program product, receiver, and communication system of the independent claims. A corresponding computer-readable storage medium and a vehicle comprising an improved receiver in accordance with the invention are presented in additional claims.

Prior to describing the method in accordance with the invention an underlying channel model will be described. Assume that the ROI comprises N_{U} single-antenna UEs, and N_{A} multi-antenna APs equipped with N_{R} receive antennas each. As illustrated in FIG. 2, the effective channel between the UEs and APs consists of two components, the line-of-sight (LOS) component which is the direct path between the UEs and APs, and the non-line-of-sight (NLOS) component which encompasses the scattered paths through the voxels representing scatterer objects, as described further above. The NLOS component may further be decomposed into two subpaths, the UE-to-voxel subpath and the voxel-to-AP subpath, which with the voxel scattering coefficient comprises the aggregate NLOS channel.

In light of the above decomposition, the effective channel between the N_{U} UEs and N_{A}N_{R} receive antennas (i.e., for all N_{R} antennas per each of the N_{A} APs), is given by

$$G = {\overbrace{H}}^{UE - to - AP path} + {\underbrace{A}}_{voxel - to - AP path} {\overbrace{diag ( v )}}^{voxel coefficients} \cdot {\underbrace{B}}_{UE - to - voxel path} ∈ {ℂ}^{{N}_{A} {N}_{R} \times {N}_{U}} ,$$

where G∈ [symbol] ^{N}^{_{A}}^{N}^{_{R}}^{×N}^{_{U}} is the effective channel matrix, H∈ [symbol] ^{N}^{_{A}}^{N}^{_{R}}^{×N}^{_{U}}, A ∈ [symbol] ^{N}^{_{A}}^{N}^{_{R}}^{×N}^{_{V}}, and B∈ [symbol] ^{N}^{_{V}}^{N}^{_{U}} are the constituting channel matrices respectively for the UE-to-AP LOS path, voxel-to-AP NLOS subpath, and UE-to-voxel NLOS subpath, and v∈ [symbol] ^{N}^{_{V}}^{×1} is the vector containing all scattering coefficients of the voxelated grid. The elements of the channel matrices H, A, and B are assumed to follow a zero-mean complex Normal distribution with variances

$${σ}_{H}^{2} , {σ}_{A}^{2} , and {σ}_{B}^{2} ,$$

respectively.

It is important to notice that the channel model in the equation shown above assumes that all paths between UEs, APs, and voxels are fully available, similarly as in the known system discussed above in the background section. However, in reality many paths may be rendered infeasible due to various physical phenomena. For example, if the angle between the incident and reflected path is too large and exceeds the critical angle, the corresponding NLOS path will not be available, as shown in FIG. 5.

Likewise, if an occupied voxel is directly in line with the path, as also shown in FIG. 5, the corresponding path will not be available. The determination of the critical angle is dependent on the electromagnetic properties of the RF wave and the environment, e.g., on the operating frequency, and hence a simplified model is proposed to approximately incorporate such phenomena into the channel matrices of the voxelated grid environment model.

First, the positions of the UEs and the APs are discretized into the 3D grid of the voxelated environment model, such that their positions may be equivalently described by the voxel coordinates. Note that it is also assumed that the multiple antennas of the respective APs are fully located within a single voxel, such that their angles-of-arrival (AoA) are assumed to be identical, while having different channel path coefficients. Given the 3D coordinates of the UE AP, and the voxel as c_{U}=[\hat{x}_{U}, y_{U}, \hat{x}_{U}]^{T}∈ [symbol] ³, c_{A}=[\hat{x}_{A}, y_{A}, \hat{x}_{A}]^{T}∈ [symbol] ³, and c_{V}=[\hat{x}_{V}, y_{V}, \hat{x}_{V}]^{T}∈ [symbol] ³, respectively, the scattering angle θ of the path at the voxel may be computed as

$$θ = arccos ( \frac{{( {c}_{U} - {c}_{V} )}^{T} ( {c}_{A} - {c}_{V} )}{\vert {c}_{U} - {c}_{V} \vert \vert {c}_{A} - {c}_{V} \vert} ) ∈ [ 0 ° , 180 ° ] ,$$

where the arccos(⋅) operator denotes the inverse cosine trigonometric function. The scattering angle θ at all voxels may be calculated for all pairs of UEs and APs, and by introducing an arbitrary critical angle θ_{crit} ∈[0°, 180° ], a scattered path is determined to be unavailable if θ>θ_{crit}, and the corresponding paths are removed from the NLOS channel matrices.

The effect of the critical angle θ_{crit} on the severity of puncturing on the channel matrices is illustrated in FIG. 6, where the result is obtained by numerical evaluations with random numbers and positions of UEs and APs for various voxelated grid resolutions, with the average channel puncturing rate normalized by the total number of path vertices (N_{A}+N_{R}). As expected, the puncturing rate shows a smooth increase between θ_{crit}=180° with no puncturing, and θ_{crit}=0° with full puncturing. This inherently includes the blocked LOS case, since the blockages may be regarded as a case with θ=180°. As mentioned above, the true critical angle is dependent on the elaborate electromagnetic properties of the environment, but its determination is out of scope of this specification. However, a very interesting behaviour is observed where the severity of puncturing becomes effectively invariant to the resolution of the voxelated environment model, i.e., the size of the voxels, converging to the same relationship at a sufficiently high resolution.

As illustrated in FIG. 6, the convergent curve may be very closely approximated by a scaled Gaussian curve, where a heuristic search yields the optimal parameterization of N(−9.8, 54²) with a scaling factor

$${( \frac{13}{96599} )}^{- 1}$$

Drawing from the above, an efficient model of the puncturing behaviour is proposed by introducing the feasibility coefficient ξ∈[0, 1] which follows a Bernoulli distribution with probability p_{ξ} obtained by evaluating the scaled Gaussian distribution

$${( \frac{13}{96599} )}^{- 1} \cdot N ( - 9.8 , 5 {4}^{2} ) at {θ}_{crit} .$$

Then, independent and identically distributed (i.i.d.) feasibility coefficients are multiplied to each element of the channel matrices, and capture the behaviour of the infeasible paths being unavailable and punctured.

Now, in a system shown in FIG. 7 and within the model developed above, consider an uplink communication scenario between N_{U} UEs and N_{A} APs. It is assumed at the N_{A} APs are connected to a central processing unit (CPU) via an error-free backhaul link with unlimited throughput, such that the received signals at all N_{A}N_{R} receive antennas are aggregated. The aggregated received signal matrix Y, over N_{T} discrete transmission instances, i.e., symbol slots, is given by

$$Y = GX + W ∈ {ℂ}^{{N}_{A} {N}_{R} \times {N}_{T}} ,$$

where G∈ [symbol] ^{N}^{_{A}}^{N}^{_{R}}^{×N}^{_{U}} is the effective channel matrix as described further above, X∈ [symbol] ^{N}^{_{U}}^{N}^{_{T}} is the transmit signal matrix collecting the transmit symbols from all N_{U} UEs, with each symbol drawn from the symbol constellation Ξ with cardinality N_{X}, and W∈ [symbol] ^{N}^{_{A}}^{N}^{_{R}}^{×N}^{_{T}} is the receive additive white Gaussian noise (AWGN) matrix with i.i.d. elements drawn from CN(0, N₀) where N₀ is the noise variance.

The transmit signal X comprises a pilot block and a data block, which is described by

$$X = [ {X}_{P} {X}_{D} ] ∈ {ℂ}^{{N}_{U} \times {N}_{T}}$$

where Xₚ ∈ [symbol] ^{N}^{_{U}}^{N}^{_{P}} and X_{D} ∈ [symbol] ^{N}^{_{U}}^{×N}^{_{D}} are the pilot and data symbol matrices respectively, with N_{P} and N_{D} denoting the number of symbol slots allocated to the pilot and data sequences respectively, such that N_{T}=N_{P}+N_{D}. The pilot symbol matrix X_{P} is assumed to be perfectly known at the CPU, and hence the communication objective of the CPU is to estimate the unknown data symbol matrix X_{D}.

By combining the models of the received signal Y, the transmit signal X, and the channel decomposition G presented above, the overall system model may be written as

$$Y = {\overbrace{( H + A diag ( v ) B )}}^{{=}^{Δ} G} {\overbrace{[ {X}_{P} {X}_{D} ]}}^{{=}^{Δ} X} + W ∈ {ℂ}^{{N}_{A} {N}_{R} \times {N}_{T}} ,$$

where the unknown variables of interest are the environment, i.e., the voxel coefficients, vector v and the data symbol matrix X_{D}. The two variables have an atypical relationship described by the asymmetric bilinear system in the system model equation above, with the environment vector v embedded within the effective channel G. Such an elaborate structure implies a difficult challenge for the joint estimation problem of the two variables v and X_{D}, which is the main objective of the JCAS method performed at the receiver, i.e., the CPU aggregating the received signals from all APs.

The present invention utilizes a bilinear message passing method for estimating the two variables v and X_{D}. However, the unique asymmetric structure of the system model equation presented above prevents the application of existing bilinear estimators such as the bilinear generalized approximate message passing (BiGAMP) proposed by J. T. Parker, P. Schniter, and V. Cevher in “Bilinear generalized approximate message passing—part i: Derivation,” IEEE Transactions on Signal Processing, vol. 62, no. 22, pp. 5839-5853, 2014, or by H. Iimori, T. Takahashi, K. Ishibashi, G. T. F. de Abreu, and W. Yu in “Grant-free access via bilinear inference for cell-free MIMO with low-coherence pilots,” IEEE Transactions on Wireless Communications, vol. 20, no. 11, pp. 7694-7710, 2021, which only operate on symmetric systems such as Y=VX+W to jointly estimate V and X, or the parametric BiGAMP as presented by J. T. Parker and P. Schniter in “Parametric bilinear generalized approximate message passing,” IEEE Journal of Selected Topics in Signal Processing, vol. 10, no. 4, pp. 795-808, 2016, or by Z. Yuan, Q. Guo, and M. Luo in “Approximate message passing with unitary transformation for robust bilinear recovery,” IEEE Transactions on Signal Processing, vol. 69, pp. 617-630, 2021, which work on systems with the structure Y=ΣₖνₖAₖX+W to jointly estimate νₖ and X with known Aₖ.

The considered system represented by the system model equation presented above is clearly in neither of the forms, nor can it be transformed to fit the general bilinear forms, such that, in accordance with the present invention, a method of processing wireless communication signals for use in JCAS leveraging the Gaussian belief propagation (GaBP) message passing framework is provided, resulting in a tailored bilinear Gaussian belief propagation (BiGaBP) message passing for the joint estimation of v and X_{D} in the asymmetric bilinear system modelled above.

Belief propagation is used for performing inference on graphical models by calculating the marginal distribution for each unobserved node or variable, conditional on any observed node or variable. Gaussian belief propagation is a variant of the belief propagation algorithm when the underlying distributions are approximated by Gaussian distributed variables. Bilinear inference operates on a similar basis to the linear inference, but simultaneously tries to recover an estimate for a function of two set of variables by inferring its value from each variable independently and considering the inferred values from all variable distributions.

The proposed method utilizes only a single bilinear estimation module which enables the estimation of both of the two unknown variables in parallel by using a bilinear message passing technique which incorporates the uncertainty of both variable estimates at each iteration, as illustrated in FIG. 8.

The BiGaBP message passing is performed on a factor graph which is a tripartite graph in presence of the two estimated variables, as shown in FIG. 9. Each element y_{m,t} of the received signal Y, with m∈{1, . . . , N_{A}N_{R}} and t∈{1, . . . , N_{T}}, corresponds to the factor nodes, shown as square nodes in the figure. The factor nodes correspond to a known observation, i.e., the received symbols at each antenna of each AP.

Two sets of variable nodes are present, shown as circular nodes in the figure, corresponding to the unknown environment vector v, with elements \hat{v}ₖ and k∈{1, . . . , N_{V}}, and the unknown signal matrix X, with elements \hat{x}_{n,t} and n∈{1, . . . , N_{U}}, respectively.

Notice the complexity of the factor graph edges arising from the asymmetric and embedded system structure of the system model equation presented above in relation to both variables together. An important distinction is made between the two types of variable nodes, which is that a data variable node receives messages from only N_{A}N_{R} factor nodes corresponding to the same time instance t, while an environment variable node receives messages from all N_{A}N_{R}N_{T} factor nodes.

The messages transferred over the graph edges comprise soft-replicas of each variable node element \hat{v}ₖ, \hat{x}_{n,t}, denoted by \hat{v}_{k:m,t} and \hat{x}_{m,t:n,t}, that are available at each factor node ∀ k and n. The soft-replicas can be understood to be the estimate of the true variable, from the perspective of each given node, i.e., the number of soft-replicas of a given single variable is equal to the number of observation nodes. The soft-replicas may be considered representing an initialized environment and initialized symbols, respectively, for the inference.

Since neither of the two variables are assumed to be known, i.e., are only known as soft-replicas, the corresponding calculation of the messages will incorporate the uncertainties in both variables, in the form of the respective MSEs. Likewise, the corresponding conditional probability distribution functions (PDFs) for each soft-estimate \hat{v}_{k:m,t} and \hat{x}_{m,t:n,t} are available at each factor node.

The mean-squared-error (MSE) of the soft-replicas \hat{v}_{k:m,t} available at each (m,t)-th factor node on the factor graph for each variable node element \hat{v}ₖ, is given by

$${ψ}_{k : m , t}^{v} = {𝔼}_{{v}_{k}} [ {\vert {v}_{k} - {\hat{v}}_{k : m , t} \vert}^{2} ] .$$

The MSE of the soft-replicas \hat{x}_{m,t:n,t} of the transmit signal matrix element \hat{x}_{n,t} that is available at each (m,t)-th factor node on the factor graph is given by

$${ψ}_{m , t : n , t}^{x} = {𝔼}_{{x}_{n , t}} [ {\vert {x}_{n , t} - {\hat{x}}_{m , t : n , t} \vert}^{2} ] .$$

In accordance with the invention, the messages exchanged in the BiGaBP are constructed on the basis of soft-replicas of the variables. It is recalled that the data variables \hat{x}_{n,t} corresponding to t∈{1, . . . , N_{P}} are pilot symbols which are perfectly known at the receiver, such that all respective soft-replicas are set to the respective known pilot value, i.e., \hat{x}_{m,t:n,t}=(\hat{x}ₚ)_{n,t} ∀t∈{1, . . . , N_{P}}, and the corresponding MSE values are set to 0. The remaining soft-replicas and MSEs for t∈{N_{P}+1, . . . , N_{T}} are determined as defined before.

Using the soft-replicas and their MSEs, the factor nodes perform soft-interference cancellation (IC) for each variable \hat{v}ₖ and \hat{x}_{n,t} by

$$\begin{matrix}{\overline{y}}_{k : m , t} = {y}_{m , t} - {\sum }_{u}^{{N}_{U}} ( {h}_{m , u} + {\sum }_{i \neq k}^{{N}_{V}} ( {a}_{m , i} \cdot {\hat{u}}_{i : m , t} \cdot {b}_{i , u} ) ) {\hat{x}}_{u , t : m , t} \\ = {u}_{k} ( {a}_{m , k} {\sum }_{u}^{{N}_{U}} {b}_{k , u} \cdot {x}_{u , t} ) + {\sum }_{u}^{{N}_{U}} {h}_{m , u} ( {x}_{u , t} - {\hat{x}}_{u , t : m , t} ) + \\ {\underbrace{{\sum }_{u}^{{N}_{U}} {\sum }_{i \neq k}^{{N}_{V}} {a}_{m , i} \cdot {b}_{i , u} ( {u}_{i} \cdot {x}_{u , t} - {\hat{u}}_{i : m , t} \cdot {\hat{x}}_{u , t : m , t} ) + {w}_{m , t}}}_{SGA}\end{matrix} ,$$

$$\begin{matrix}{\overline{y}}_{n , t : m , t} = {y}_{m , t} - {\sum }_{u}^{{N}_{U}} ( {h}_{m , u} + {\sum }_{i}^{{N}_{V}} ( {a}_{m , i} \cdot {\hat{u}}_{i : m , t} \cdot {b}_{i , u} ) ) {\hat{x}}_{u , t : m , t} \\ = {x}_{n , t} ( {h}_{m , n} + {\sum }_{i}^{{N}_{V}} ( {a}_{m , i} \cdot {u}_{i} \cdot {b}_{i , n} ) ) + {\sum }_{u \neq n}^{{N}_{U}} {h}_{m , u} ( {x}_{u , t} - {\hat{x}}_{u , t : m , t} ) + \\ {\underbrace{{\sum }_{u \neq n}^{{N}_{U}} {\sum }_{i}^{{N}_{V}} {a}_{m , i} \cdot {b}_{i , u} ( {u}_{i} \cdot {x}_{u , t} - {\hat{u}}_{i : m , t} \cdot {\hat{x}}_{u , t : m , t} ) + {w}_{m , t}}}_{SGA}\end{matrix} ,$$

where the soft-IC for the data variables given in the equation for y̅_{n,t:m,t} is only performed for t∈{N_{P}+1, . . . , N_{T}}. Note that SGA is the scalar Gaussian approximation.

Following the soft-IC, the respective conditional PDFs, which specify the probability of a random variable falling within a particular range of values, as opposed to taking on any one value, of the now interference-free signals are obtained via:

$${ℙ}_{{\overline{y}}_{k : m , t}^{v}} ( {\overline{y}}_{k : m , t}^{u} \vert {u}_{k} ) ∝ exp [ - \frac{{\vert {\overline{y}}_{k : m , t}^{u} - ( {a}_{m , k} {\sum }_{u = 1}^{{N}_{U}} {b}_{k , u} \cdot {\hat{x}}_{u , t : m , t} ) {U}_{k} \vert}^{2}}{{V}_{k : m , t}^{v}} ] ,$$

$${ℙ}_{{\overline{y}}_{n , t : m , t}^{x}} ( {\overline{y}}_{n , t : m , t}^{x} \vert {x}_{n , t} ) ∝ exp [ - \frac{{\vert {\overline{y}}_{n , t : m , t}^{x} - ( {h}_{m , n} + {\sum }_{i = 1}^{{N}_{V}} {a}_{m , i} \cdot {\hat{u}}_{i : m , t} \cdot {b}_{i , n} ) {x}_{n , t} \vert}^{2}}{{V}_{n , t : m , t}^{x}} ] ,$$

where the respective conditional variances

$${v}_{k : m , t}^{v} and {v}_{n , t : m , t}^{x}$$

are obtained by

$$\begin{matrix}{{v}_{k : m , t}^{u} = {𝔼}_{\{ {v}_{k ,} {x}_{n , t} \}} [ {\overline{y}}_{k : m , t}^{x} - ( {a}_{m , k} {\sum }_{u}^{{N}_{U}} {b}_{k , u} \cdot {\hat{x}}_{u , t : m , t} ) {u}_{k} \vert}^{2} ] \\ = {E}_{v} \cdot {\vert {a}_{m , k} \vert}^{2} {\sum }_{u}^{{N}_{U}} {\vert {b}_{k , u} \vert}^{2} {ψ}_{u , t : m , t}^{x} + {\sum }_{u}^{{N}_{U}} {\vert {h}_{m , u} \vert}^{2} {ψ}_{u , t : m , t}^{x} + \\ {\sum }_{u}^{{N}_{U}} {\sum }_{i \neq k}^{{N}_{V}} {\vert {a}_{m , i} \vert}^{2} ( {ψ}_{i : m , t}^{u} {\vert {\hat{x}}_{u , t : m , t} \vert}^{2} + {ψ}_{u , t : m , t}^{x} ( {\vert {\hat{u}}_{i : m , t} \vert}^{2} + {ψ}_{i : m , t}^{u} ) ) {\vert {b}_{i , u} \vert}^{2} + {N}_{0}\end{matrix} ,$$

$$\begin{matrix}{v}_{n , t : m , t}^{x} = {𝔼}_{\{ {v}_{k ,} {x}_{n , t} \}} [ {\vert {\overline{y}}_{n , t : m , t}^{x} - ( {h}_{m , n} + {\sum }_{i}^{{N}_{V}} {a}_{m , i} \cdot {\hat{u}}_{i : m , t} \cdot {b}_{i , n} ) {x}_{n , t} \vert}^{2} ] \\ = {E}_{X} \cdot {\sum }_{i}^{{N}_{V}} ( {\vert {a}_{m , i} \vert}^{2} {ψ}_{i : m , t}^{u} {\vert {b}_{i , n} \vert}^{2} ) + {\sum }_{u \neq n}^{{N}_{U}} ( {\vert {h}_{m , u} \vert}^{2} {ψ}_{u , i : m , t}^{x} ) + \\ {\sum }_{u \neq n}^{{N}_{U}} {\sum }_{i}^{{N}_{V}} {\vert {a}_{m , i} \vert}^{2} ( {ψ}_{i : m , t}^{u} {\vert {\hat{x}}_{u , i : m , t} \vert}^{2} + {ψ}_{u , t : m , t}^{x} ( {\vert {\hat{u}}_{i : m , t} \vert}^{2} + {ψ}_{i : m , t}^{u} ) ) {\vert {b}_{i , u} \vert}^{2} + {N}_{0}\end{matrix} ,$$

with the expectation Eᵥ≅ [symbol] ᵥ_{ₖ}_{}}[|\hat{v}ₖ|²] being introduced.

In turn, all variable nodes compute the interference-cancelled extrinsic belief PDFs given by

$${ℙ}_{{I}_{k : m , t}^{v}} ( {ℓ}_{k : m , t}^{u} \vert {u}_{k} ) = {\prod }_{p \neq m , q \neq t}^{{N}_{A} {N}_{R} , {N}_{T}} ℙ ( {\overline{y}}_{k : p : q}^{u} \vert {u}_{k} ) ∝ exp [ - \frac{{\vert {u}_{k} - {μ}_{k : m , t}^{u} \vert}^{2}}{{Ψ}_{k : m , t}^{u}} ] ,$$

$${ℙ}_{{I}_{m , t : m , t}^{x}} ( {ℓ}_{n , t : m , t}^{x} \vert {x}_{n , t} ) = {\prod }_{p \neq m}^{{N}_{A} {N}_{R}} ℙ ( {\overline{y}}_{n , t : p : q}^{x} \vert {x}_{n , t} ) ∝ exp [ - \frac{{\vert {x}_{n} - {μ}_{n , t : m , t}^{x} \vert}^{2}}{{Ψ}_{n , t : m , t}^{x}} ] ,$$

with the respective extrinsic variances and extrinsic means are given by

$${ψ}_{k : m , t}^{u} = {( {\sum }_{p \neq m , q \neq t}^{{N}_{A} {N}_{R} , {N}_{T}} \frac{{\vert {a}_{p , k} {\sum }_{u = 1}^{{N}_{U}} {b}_{k , u} \cdot {\hat{x}}_{u , q \text{::} p , q} \vert}^{2}}{{V}_{k : p , q}^{u}} )}^{- 1} ,$$

$${μ}_{k : m , t}^{u} = {ψ}_{k : m , t}^{u} \cdot ( {\sum }_{p \neq m , q \neq t}^{{N}_{A} {N}_{R} , {N}_{T}} \frac{{( {a}_{p , k} {\sum }_{u = 1}^{{N}_{U}} {b}_{k , u} \cdot {\hat{x}}_{u , q \text{::} p , q} )}^{*} \cdot {\overline{y}}_{k : p : q}^{u}}{{v}_{k : p , q}^{u}} ) ,$$

$${ψ}_{n , t : m , t}^{x} = {( {\sum }_{p \neq m}^{{N}_{A} {N}_{R}} \frac{{\vert {h}_{p , n} + {\sum }_{i = 1}^{{N}_{V}} {a}_{p , i} \cdot {\hat{u}}_{i : p , t} \cdot {b}_{i , n} \vert}^{2}}{{V}_{n , t : p , t}^{x}} )}^{- 1} ,$$

$${μ}_{n , t : m , t}^{x} = {ψ}_{n , t : m , t}^{x} \cdot ( {\sum }_{p \neq m}^{{N}_{A} {N}_{R}} \frac{{( {h}_{p , n} + {\sum }_{i = 1}^{{N}_{V}} {a}_{p , i} \cdot {\hat{u}}_{i : p , t} \cdot {b}_{i , n} )}^{*} \cdot {\overline{y}}_{n , t : p , t}^{x}}{{V}_{n , t : p , t}^{x}} ) .$$

from which the updated soft-replicas and the MSEs are obtained as described in the following.

Following the Bayes rule the updated soft replicas and MSEs for \hat{v}_{k:m,t} may be obtained by combining the PDF of the extrinsic belief and the prior distribution of \hat{v}ₖ, from which the updated soft-replica is obtained by

$${\hat{u}}_{k : m , t} = {𝔼}_{{v}_{k}} [ \frac{{ℙ}_{{I}_{k : m , t}^{v}} ( {ℓ}_{k : m , t}^{u} \vert {u}_{k} ) \cdot {ℙ}_{{v}_{k}} ( {u}_{k} )}{{Z}_{k : m , t}^{u}} ] ,$$

where the corresponding normalizing factor is given by integrating the updated posterior over the complex field to yield

$${Z}_{k : m , t}^{u} = {\int }_{{v}_{k}} {ℙ}_{{I}_{k : m , t}^{v}} ( {ℓ}_{k : m , t}^{u} \vert {u}_{k} ) \cdot {ℙ}_{{v}_{k}} ( {u}_{k} ) ,$$

and the updated error variance of the soft-replica is similarly obtained by evaluating

$${ψ}_{k : m , t}^{u} = {Var}_{{v}_{k}} [ \frac{{ℙ}_{{I}_{k : m , t}^{v}} ( {ℓ}_{k : m , t}^{u} \vert {u}_{k} ) \cdot {ℙ}_{{v}_{k}} ( {u}_{k} )}{{Z}_{k : m , t}^{u}} ] ,$$

The updated soft replicas and MSEs for \hat{x}_{m,t:n,t} are obtained by

$${\overline{x}}_{n , t : m , t} = \frac{{\sum }_{x ∈ {X}^{x}} \cdot {ℙ}_{{I}_{n , t : m , t}^{x}} ( {ℓ}_{n , t : m , t}^{x} \vert x ) \cdot {ℙ}_{x} ( x )}{{Z}_{n , t : m , t}^{x}} ,$$

$${ψ}_{n , t : m , t}^{x} = \frac{{\sum }_{x ∈ {X}^{{x}^{2}}} \cdot {ℙ}_{{I}_{n , t : m , t}^{x}} ( {ℓ}_{n , t : m , t}^{x} \vert x ) \cdot {ℙ}_{x} ( x )}{{Z}_{n , t : m , t}^{x}} - {( {\hat{x}}_{n , t : m , t} )}^{2} , and$$

$${Z}_{n , t : m , t}^{x} = {\sum }_{x ∈ X} \cdot {ℙ}_{{I}_{n , t : m , t}^{x}} ( {ℓ}_{n , t : m , t}^{x} \vert x ) \cdot {ℙ}_{x} ( x )$$

The updated soft-replica and the MSE of each variable node are transmitted back to all factor nodes for the next iteration of the BiGaBP message passing method.

To prevent early convergence to a local optimum, a well-known technique of damped updating is applied, at the variable nodes, to obtain the final updated values:

$${\hat{v}}_{k : m , t}^{( ℓ + 1 )} = ( 1 - β ) {\hat{v}}_{k : m , t}^{[ ℓ ]} + β {\hat{v}}_{k : m , t} ,$$

$${\hat{x}}_{n , t : m , t}^{( ℓ + 1 )} = ( 1 - β ) {\hat{x}}_{n , t : m , t}^{[ ℓ ]} + β {\hat{x}}_{n , t : m , t} ,$$

$${ψ}_{k : m , t}^{v ( ℓ + 1 )} = ( 1 - β ) {ψ}_{k : m , t}^{v [ ℓ ]} + {βψ}_{k : m , t}^{v} ,$$

$${ψ}_{n , t : m , t}^{x ( ℓ + 1 )} = ( 1 - β ) {ψ}_{n , t : m , t}^{x [ ℓ ]} + {βψ}_{n , t : m , t}^{x} ,$$

where [symbol] is the iteration number, and β∈[0,1] is the damping factor.

After a given number of BiGaBP iterations to refine the soft-estimates, a belief consensus is taken at each variable node across the soft-replicas to obtain a single estimate.

The belief consensus for obtaining a single estimate v is achieved by

$${ℙ}_{{I}_{k}^{v}} ( {\overline{ℓ}}_{k}^{v} \vert {u}_{k} ) = {\prod }_{p \neq 1 , q \neq 1}^{{N}_{A} {N}_{R} , {N}_{T}} {ℙ}_{{\overline{y}}_{k : m : t}^{v}} ( {\overline{y}}_{k : p : q}^{u} \vert {u}_{k} ) ∝ exp [ - \frac{{\vert {u}_{k} - {\overline{μ}}_{k}^{u} \vert}^{2}}{{\overline{Ψ}}_{k}^{u}} ] ,$$

whose variance

$${\tilde{ψ}}_{k}^{v}$$

and mean

$${\tilde{μ}}_{k}^{v}$$

are expressed as

$${\overline{Ψ}}_{k}^{u} = {( {\sum }_{p = 1 , q = 1}^{{N}_{A} {N}_{R} , {N}_{T}} \frac{{\vert {a}_{p , k} \vert}^{2} {\vert {c}_{k , t} \vert}^{2}}{{v}_{k : p , q}^{u}} )}^{- 1} ,$$

$${\overline{μ}}_{k}^{u} = {\overline{Ψ}}_{k}^{u} \cdot ( {\sum }_{p = 1 , q = 1}^{{N}_{A} {N}_{R} , {N}_{T}} \frac{{( {a}_{p , k} {c}_{k , t} )}^{*} \cdot {\overline{y}}_{k : p , q}^{u}}{{v}_{k : p , q}^{u}} ) ,$$

and is consequently used to yield the final estimate by

$${v}_{k} = 𝔼 \text{?} [ \frac{ℙ \text{?} ( {ℓ}_{k}^{v} \text{?} \vert {v}_{k} ) \cdot ℙ \text{?} ( {v}_{k} )}{Z \text{?}} ] ,$$

$$with$$

$$Z \text{?} = \int \text{?} ℙ \text{?} ( {\tilde{ℓ}}_{k}^{v} \vert {v}_{k} ) \cdot ℙ \text{?} ( {v}_{k} ) .$$

$$\text{?} \text{indicates text missing or illegible when filed}$$

The belief consensus for obtaining a single estimate x is achieved by

$$ℙ \text{?} ( {\tilde{ℓ}}_{m , t}^{x} \vert {x}_{n , t} ) = {{\prod }_{p = 1}}^{{N}_{A} {N}_{R}} ℙ \text{?} ( {y}_{n , t : p , t}^{x} \text{?} \vert {x}_{n , t} ) ∝ exp [ - \frac{{\vert {x}_{n , t} - {\tilde{μ}}_{n , t}^{x} \vert}^{2}}{{\tilde{Ψ}}_{n , t}^{x}} ] ,$$

$$\text{?} \text{indicates text missing or illegible when filed}$$

whose variance

$${\tilde{ψ}}_{n , t}^{x}$$

and mean

$${\tilde{μ}}_{n , t}^{x}$$

are expressed as

$${\tilde{Ψ}}_{n , t}^{x} = {( {\sum }_{p = 1}^{{N}_{A} {N}_{R}} \frac{{\vert {g}_{p , n} \vert}^{2}}{{ν}_{n , t : p ,}^{x} \text{?}} )}^{- 1} ,$$

$${\tilde{μ}}_{n , t}^{x} = {Ψ}_{n , t}^{x} \cdot ( {\sum }_{p = 1}^{{N}_{A} {N}_{R}} \frac{{( {g}_{p , n} )}^{*} \cdot {y}_{n , t : p , i}^{x} \text{?}}{{ν}_{n , t : p ,}^{x} \text{?}} ) ,$$

$$\text{?} \text{indicates text missing or illegible when filed}$$

yielding the final soft estimate by

$${\tilde{x}}_{n , t : m , t} = {\sum }_{x ∈ Ξ} x \cdot {ℙ}_{{\tilde{I}}_{n , t}^{x}} ( {\tilde{ℓ}}_{n , t}^{x} \vert {x}_{n , t} ) \cdot {ℙ}_{{x}_{n , t}} ( {x}_{n , t} )$$

$$with$$

$${\tilde{Z}}_{n , t : m , t}^{x} = {\sum }_{x ∈ Ξ} x \cdot {ℙ}_{{\tilde{I}}_{n , t}^{x}} ( {\tilde{ℓ}}_{n , t}^{z} \vert {x}_{n , t} ) \cdot {ℙ}_{{x}_{n , t}} ( {x}_{n , t} )$$

An exemplary full bilinear JCAS (Bi-JCAS) estimation for the environment vector v and the signal matrix X, with the received signal matrix Y, the channel matrices H, A, and B, the pilot matrix Xₚ, the noise variance No, and the prior distribution of environment and transmit symbols [symbol] ᵥ_{ₖ}(\hat{v}ₖ) and [symbol] ₓ_{_{n,t}}(\hat{x}_{n,t}) as inputs and the estimated environment vector \tilde{v} and the estimated transmit signal matrix \tilde{X} as outputs can be summarized as follows, with reference to the steps of the method 100 shown in FIG. 10:
102: Receive, at the N_{R} antennas respectively associated with the N_{A} access points (AP), N_{T}≥1 transmission instances, the N_{T} transmission instances carrying a plurality of sent communication signals (\hat{x}_{n,t}) comprising pilot signals and data signals, sent by the N_{U} UEs (UE).

Optionally, for data variable nodes corresponding to the pilot block, i.e., for t∈{1, . . . , N_{P}}, and for all m, n:
104a: Initialize the soft-replicas as pilots by \hat{x}_{n,t:m,t}=(\hat{x}ₚ)_{n,t}.
104b: Initialize the MSEs

$${ψ}_{m , t : n , t}^{x}$$

to 0.

Further optionally, for data variable nodes corresponding to the data block, i.e., for t∈{N_{P}+1, . . . , N_{T}}, and for all m, n:
106a: Initialize the soft-replicas as \hat{x}_{n,t:m,t}= [symbol] ₓ_{_{n,t}}[\hat{x}_{n,t}].
106b: Initialize the

$$M S E s {ψ}_{m , t : n , t}^{x} via {ψ}_{m , t : n , t}^{x} = {𝔼}_{{x}_{n , t}} [ {\vert {x}_{n , t} - {\hat{x}}_{m , t : n , t} \vert}^{2} ] .$$

Yet further optionally, for environment variable nodes, i.e., for t∈{1, . . . , N_{T}}, and for all m, k:
108a: Initialize the environment soft-replicas as \hat{v}_{k:m,t}= [symbol] ᵥ_{ₖ}[vₖ].
108b: Initialize the

$$MSEs {ψ}_{k : m , t}^{v} via {ψ}_{k : m , t}^{v} = {𝔼}_{{v}_{k}} [ {\vert {v}_{k} - {\hat{v}}_{k : m , t} \vert}^{2} ] .$$

Note that, when present, steps 104a to 108b can be carried out sequentially or in parallel.

The core of the method comprises repeating, for all m, n, k, t, the following steps until a termination criterion is met:
110: Compute soft-IC signals

$${\overline{y}}_{k : m , t}^{v} and {\overline{y}}_{n , t : m , t}^{x} .$$

112: Compute soft-replicas (\hat{v}_{k:m,t}, \hat{x}_{n,t:m,t}) and corresponding MSEs

$$( {ψ}_{k : m , t}^{v} , {ψ}_{m , t : n , t}^{x} )$$

114: Update all soft-replicas and MSEs via damping.
116: Termination criterion met?

Step 112 may comprise several sub-steps:
112a: Compute conditional variances

$${ν}_{k : m , t}^{v} and {ν}_{n , t : m , t}^{x} .$$

112b: Compute extrinsic mean

$${μ}_{k : m , t}^{v}$$

and variance

$${ψ}_{k : m , t}^{v} .$$

112c: Compute extrinsic mean

$${μ}_{n , t : m , t}^{x}$$

and variance

$${ψ}_{n , t : m , t}^{x} .$$

112d: Compute new soft-replicas

$${\hat{v}}_{k : m , t} and {\hat{x}}_{n , t : m , t} .$$

112e: Compute new

$$MSEs {ψ}_{k : m , t}^{v} and {ψ}_{m , t : n , t}^{x} .$$

The method further comprises, after the termination criterion is met and for all n, k, t:
118a: Compute consensus PDFs using

$${\tilde{μ}}_{k}^{v} , {\tilde{μ}}_{n , t}^{x} , {\tilde{ψ}}_{k}^{v} and {\tilde{ψ}}_{n , t}^{x} .$$

118b: Compute conditional variances

$${v}_{k : m , t}^{v} and {v}_{n , t : m , t}^{x}$$

then, for all n, t:
120: Project the final soft estimate \tilde{x}_{n,t} to the symbol constellation X, and
122: Output the projected \tilde{x}_{n,t} as hard estimate.

In accordance with a first aspect of the present invention a method of processing wireless communication signals for use in joint communication and environment perception in a region of interest is proposed. The environment or the region of interest, which is represented by voxels arranged in a three-dimensional grid, comprises N_{A}≥1 access points and N_{U}≥1 UEs. Each of the N_{A} access points has N_{R}≥1 antennas. The method comprises receiving, at the N_{R} antennas respectively associated with the N_{A} access points, N_{T}≥1 transmission instances, the N_{T} transmission instances carrying a plurality of transmit symbols x_{n,t} comprising pilot signals and data signals, sent by all of the N_{U} UEs. The method further comprises performing, for each of the N_{R} antennas of each of the N_{A} access points, a soft interference cancellation to received communication signals y_{m,t} representing the transmit symbols x_{n,t}, for all voxels in the region of interest and for all transmit symbols x_{n,t}. The method yet further comprises determining, for each of the N_{R} antennas of each of the N_{A} access points, soft-replica

$${\hat{v}}_{k : m , t} , {\hat{x}}_{n , t : m , t}$$

and corresponding MSEs

$${ψ}_{k : m , t}^{v} , {ψ}_{m , t : n , t}^{x}$$

for all voxels in the region of interest and for all transmit symbols x_{n,t}, and updating (114) all soft-replicas (\hat{v}_{k:m,t}, \hat{x}_{n,t:m,t}) and corresponding MSEs

$$( {ψ}_{k : m , t}^{v} , {ψ}_{m , t : n , t}^{x} ) .$$

The steps of performing the soft interference cancellation, determining the soft-replicas and corresponding MSEs, and updating all soft replicas and corresponding MSEs are repeated while a termination criterion is not met.

The termination criterion can include, for example, a predetermined numerical iteration limit, or a convergence of the estimate within a predetermined range or below a predetermined value. Such convergence criterion can be fulfilled, e.g., when the average change between consecutive post-iteration estimates is below the predetermined value.

The method further includes, after the termination criterion is met, computing, for each voxel in the region of interest, and for each transmit symbol x_{n,t}, from the corresponding soft-replicas of each of the N_{R} antennas of each of the N_{A} access points, a respective final soft-estimate \tilde{x}_{n,t}, \tilde{v}ₖ, and projecting the final soft estimate for each transmit symbol \tilde{x}_{n,t} to the symbol constellation X. Finally, the projected transmit symbol \tilde{x}_{n,t} is output as hard estimate.

In one or more embodiments the method further comprises initializing, for all as yet unknown transmit symbols x_{n,t}, and for each of the N_{R} antennas and each of the N_{U} UEs, the soft-replicas, and/or the MSEs. Alternatively or in addition, the soft-replicas, and/or the MSEs can be initialized, for all voxels in the region of interest and for each of the N_{R} antennas, prior to performing the soft interference cancellation to received communication signals y_{m,t}.

In one or more embodiments the step of initializing the soft-replicas for all as yet unknown transmit symbols x_{n,t} corresponding to a pilot block comprises initializing the soft-replicas of the transmit signal as pilots, in accordance with the prior knowledge of the pilot signals, and or initializing the corresponding MSEs to 0.

Alternatively or in addition, the step of initializing the soft-replicas for all as yet unknown transmit symbols x_{n,t} corresponding to a data block comprises initializing the soft-replicas of the transmit signals to respective values in accordance with expectations based on a known prior probability distribution of the symbol constellation, or set. In other words, the most probable values are chosen, in accordance with the probability distribution within the set of symbols. In yet other words, the soft-replicas of the transmit signals are initialized as \hat{x}_{n,t:m,t}= [symbol] ₓ_{_{n,t}}[x_{n,t}]. Alternatively, or in addition, the corresponding MSEs may be initialized to the value of the expected error of the previously initialized soft replica. The expected error is the average Euclidean distance from the initialised soft replica to all possible symbols in the symbol set, or constellation. In other words, the MSEs are initialised as

$${ψ}_{m , t : n , t}^{x} via {ψ}_{m , t : n , t}^{x} = {𝔼}_{{x}_{n , t}} [ {\vert {x}_{n , t} - {\hat{x}}_{m , t : n , t} \vert}^{2} ] .$$

In a further alternative, or in addition to one or more of the previously mentioned initializations, the step of initializing the soft-replicas for all voxels in the region of interest comprises initializing the environment soft-replicas to respective values in accordance with an expectation of a known prior probability distribution of the voxel coefficients. In other words, the soft replicas are assigned most probable values. In yet other words, the environment soft-replicas are initialized as \hat{v}_{k:m,t}= [symbol] ᵥ_{ₖ} [vₖ].

Alternatively, or in addition, the corresponding MSEs may be initialized to the value of the expected error of the previously initialized environment soft replica. The expected error is the average Euclidean distance from value of the initialised environment soft replica to the feasible voxel occupancy states. In other words, the MSEs are initialised as

$${ψ}_{k : m , t}^{v} via {ψ}_{k : m , t}^{v} = {𝔼}_{{v}_{k}} [ {\vert {v}_{k} - {\hat{v}}_{k : m , t} \vert}^{2} ] .$$

In one or more embodiments, the expected values of the environment soft-replicas may be determined based on prior knowledge of parts of the environment, e.g., based on geo-information or the like.

In one or more embodiments determining, for each of the N_{R} antennas of each of the N_{A} access points, soft-replicas \hat{v}_{k:m,t}, \hat{x}_{n,t:m,t} and corresponding

$$MSEs {ψ}_{k : m , t}^{v} , {ψ}_{m , t : n , t}^{x} ,$$

for all voxels in the region of interest and for all transmit symbols x_{n,t}, comprises computing the conditional variances

$${v}_{k : m , t}^{v} and {v}_{n , t : m , t}^{x} ,$$

the extrinsic mean

$${μ}_{k : m , t}^{v}$$

and variance

$${ψ}_{k : m , t}^{v} ,$$

the extrinsic mean

$${μ}_{n , t : m , t}^{x}$$

and variance

$${ψ}_{n , t : m , t}^{x} ,$$

the new soft-replicas \hat{v}_{k:m,t} and \hat{x}_{n,t:m,t}, and the new

$$M S E s {ψ}_{k : m , t}^{v} and {ψ}_{m , t : n , t}^{x} .$$

In one or more embodiments computing, for each voxel in the region of interest, and for each transmit symbol x_{n,t}, from the corresponding soft-replicas of each of the N_{R} antennas of each of the N_{A} access points, a respective final soft-estimate \tilde{x}_{n,t}, \tilde{v}ₖ, comprises computing the consensus PDFs using

$${\tilde{μ}}_{k}^{v} , {\tilde{μ}}_{n , t}^{x} , {\tilde{ψ}}_{k}^{v} and {\tilde{ψ}}_{n , t}^{x} ,$$

and computing the conditional variances

$${v}_{k : m , t}^{v} and {v}_{n , t : m , t}^{x} .$$

In one or more embodiments a wireless communication signal carrying the transmit symbols uses transmission frames having data symbols and pilot symbols, the pilot symbols being known at the receiver. Data and pilot symbols may be arranged in respective transmission blocks, one or more transmission block forming a transmission frame.

In one or more embodiments the frequency of the wireless communication signal is within a radar frequency range, including a frequency range between 30 GHz and 300 GHz, particularly between 50 and 150 GHz, for instance between 57 GHz and 71 GHz. While the invention is not limited to these frequency ranges, high frequencies may exhibit an NLOS scattering behaviour that is more beneficial for the method proposed herein.

The method presented hereinbefore may be represented by computer program instructions of a computer program product. Accordingly, in a second aspect of the invention, a computer program product comprises computer program instructions, which, when executed by a processor of or functionally coupled with a receiver, cause the processor and/or the receiver to carry out a method in accordance with one or more of the various embodiments of the first aspect.

The computer program instructions may be retrievably stored or transmitted on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

In accordance with a third aspect of the present invention a receiver for wireless communication signals comprises at least one antenna, circuitry for processing radio frequency signals, a microprocessor, volatile and non-volatile memory, which elements or components are connected via one or more data and/or signal lines or buses. The non-volatile memory stores computer program instructions which, when executed by the microprocessor, configure elements or components of the receiver to implement or carry out one or more embodiments of the method in accordance with the first aspect of the present invention.

In one or more embodiments the receiver is co-located to a transmitter configured for sending communication signals.

In one or more embodiments the circuitry for processing radio frequency signals comprises a low noise amplifier and/or a mixer configured for providing a representation of a received signal at an intermediate frequency. The mixer preferably uses a same oscillator signal as a transmitter co-located with the receiver. The latter may enable using signals transmitted by the entity comprising the receiver, which are reflected off objects, for environment perception.

The receiver according to the second aspect of the invention and a corresponding transmitter configured for transmitting communication signals may form a system permitting joint communication and environment perception in accordance with embodiments of the method presented hereinbefore.

The receiver in accordance with the third aspect of the invention may be arranged in a vehicle, permitting the vehicle to create a representation of its environment, e.g., for self-driving purposes. The vehicle may also comprise a corresponding transmitter, enabling bi-directional communication.

The method presented herein provides joint communication and environment perception in scenarios with multiple independent users and multiple cooperating receivers, e.g., fully connected and automated factories, warehouses, etc., with centralized processing, such as industrial edge computing. The invention addresses the problem of how to perceive the environment and surroundings in the form of a 3D discretized image, exclusively using communication signals, i.e., user payload and pilots, in which a MIMO wireless communication system is deployed comprising of multiple UEs, acting as transmitters, and multiple antenna access points, acting as receivers.

The present invention advantageously removes the limitation of the communication and access scheme to specific transmission schemes found in known methods, such as the SCMA transmission scheme in the known method discussed in the background section, thereby inter alia dispensing with the requirement of multiple frequency subcarriers in deployment and, thus, permitting the robust application of JCAS in various situations.

Further, the present invention lifts the confinement imposed on the detection sliding window length in prior art methods, which is determined by the pilot length.

Yet further, the present invention provides a system model that is no longer limited to a single AP, and single antenna UEs, permitting exploitation of larger receive and transmit diversity as well as multiple-input and multiple-output (MIMO) techniques, which refers to a practical technique for sending and receiving more than one data signal simultaneously over the same radio channel by exploiting multipath propagation.

In addition, the present invention removes the dependency on a single RIS, which dependency restricts some known methods to specific scenarios in which such single RIS is available.

The JCAS method using BiGaBP presented hereinbefore advantageously permits the direct recovery of an environment from communication signals. As a further advantage, the BiGaBP requires only a single estimation module, as opposed to up to three iterative modules required in prior art methods. Thus, the present invention provides an actual joint sensing and communication, which now permits simultaneously considering signal and environment uncertainty, and which does not depend on a sparse signal model imposed through forced use of sparse coding.

Yet further advantageous, other than in known methods, which use pilot signals exclusively in initial stages of detecting an environment, in the inventive method the information carried in the pilot symbols is utilized throughout all steps of the environment detection procedure, improving stability and convergence.

The present invention can advantageously be used in several scenarios, inter alia by UEs in an indoor scenario with stationary Aps, communicating and detecting an environment, by mobile vehicles communicating to roadside units (RSUs) while achieving vehicular/pedestrian detection, by multiple vehicles cooperatively sensing an environment and road conditions without RSUs, by multiple connected UEs (Bluetooth, Wi-Fi, IoT, etc.) for passively sensing an environment (i.e., without the use of sensing specific signals), and the like.

### BRIEF DESCRIPTION OF THE DRAWINGS

FIGS. 1a, 1b, and 1c show an exemplary environment with objects in a region of interest.

FIG. 2 shows a representation of the general concept of LOS and NLOS paths in a voxelated space.

FIG. 3 shows an exemplary embodiment considered in a prior art JCAS method.

FIG. 4 shows the three modules and their relations used in the prior art JCAS method.

FIG. 5 shows a schematic representation of infeasible paths in the voxelated space.

FIG. 6 shows the effect of the critical angle θ_{crit} on the severity of puncturing on the channel matrices for different voxelated grid resolutions.

FIG. 7 shows an exemplary embodiment considered in the present invention.

FIG. 8 shows a schematic block diagram of the BiGaBP in accordance with the invention.

FIG. 9 shows a schematic representation of the tripartite factor graph describing the relation of factor nodes and variable nodes.

FIG. 10 shows an exemplary schematic flow diagram of the method in accordance with the invention.

FIG. 11 shows a further exemplary schematic flow diagram of the method in accordance with the invention.

FIG. 12 shows an exemplary block diagram of a receiver in accordance with the third aspect of the invention.

FIG. 13 shows an exemplary and schematic diagram of a communication system in accordance with the invention.

In the figures identical or similar elements may be referenced using the same reference designators.

### DETAILED DESCRIPTION

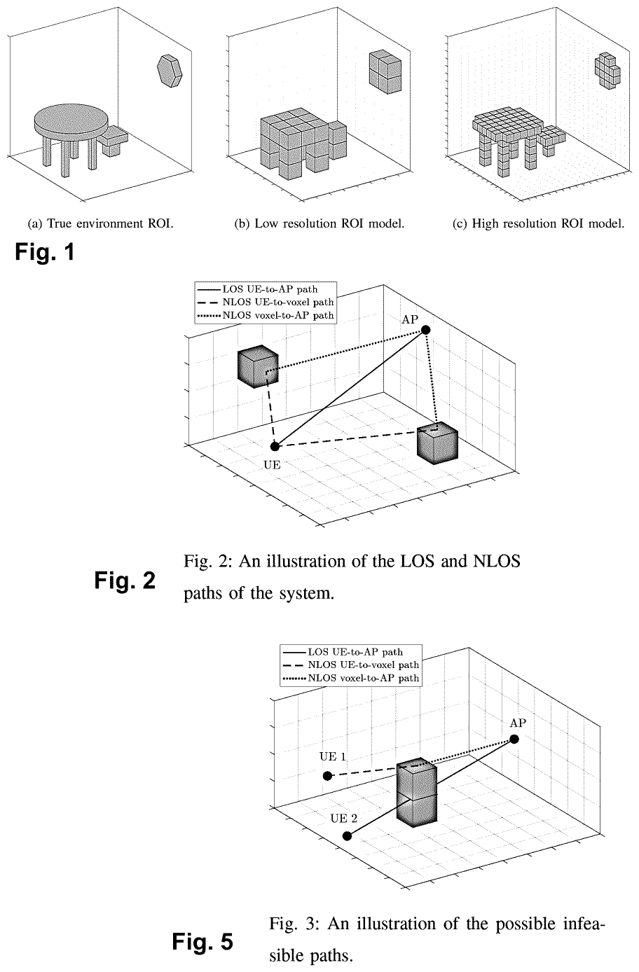

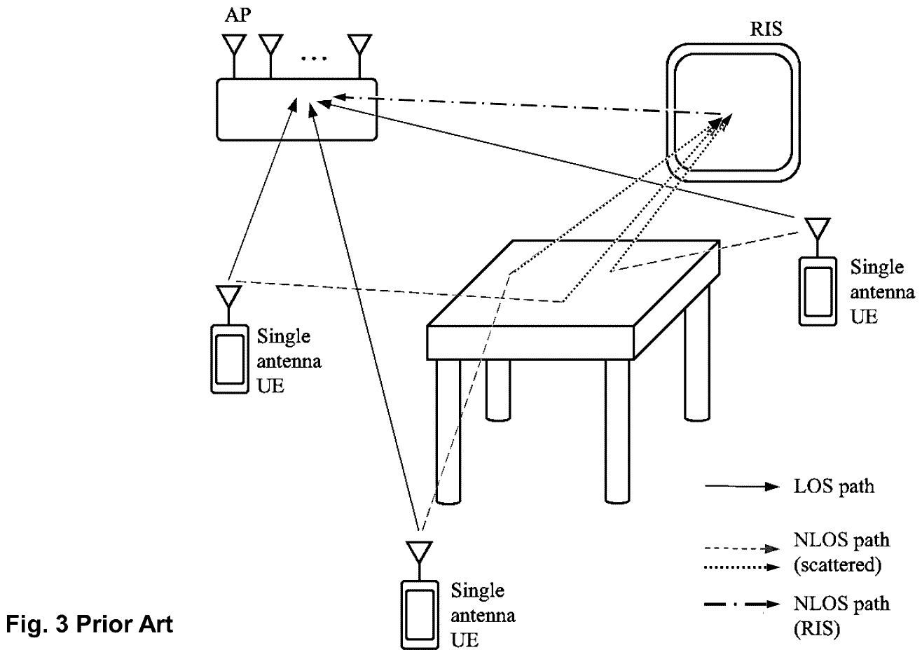

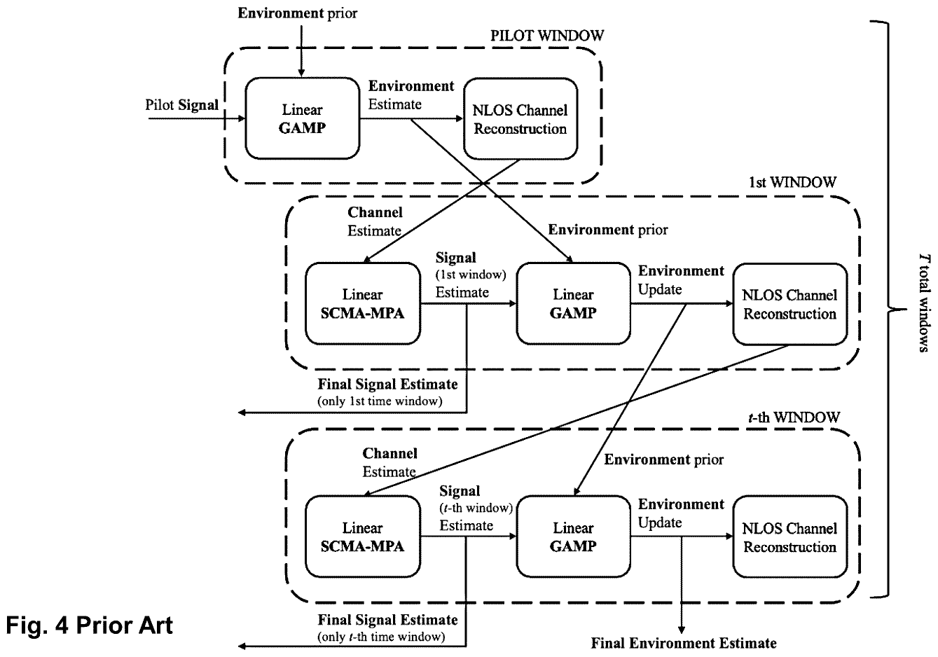

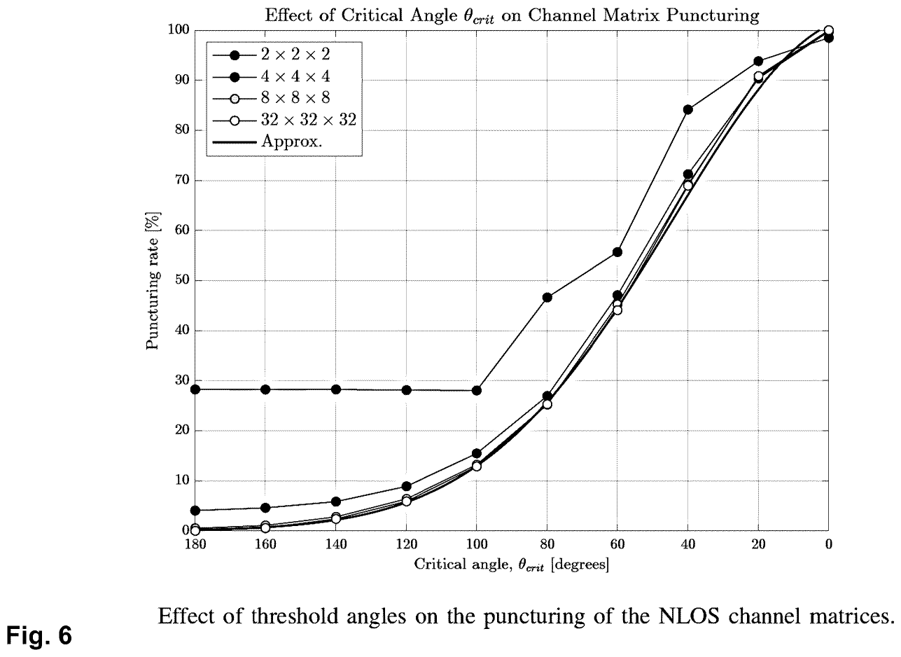

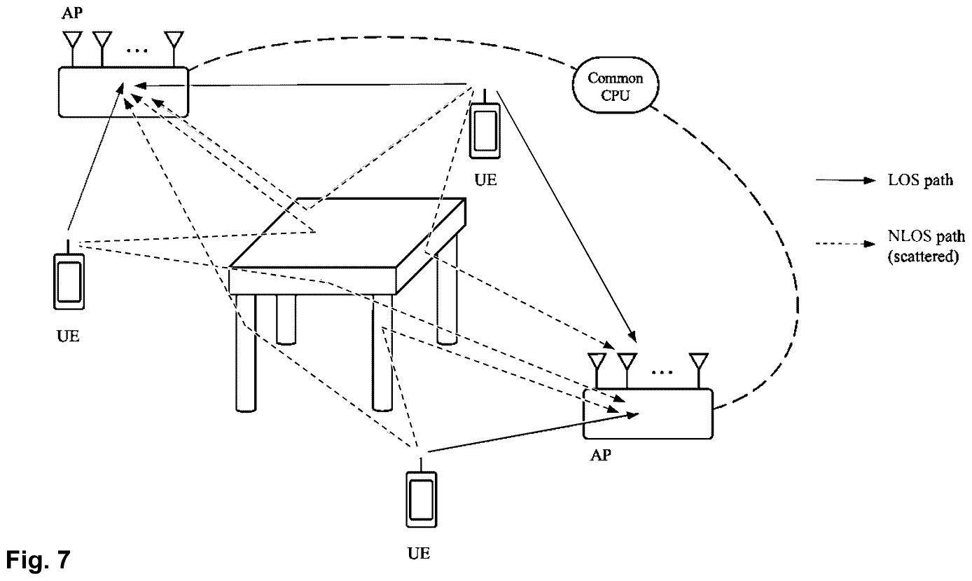

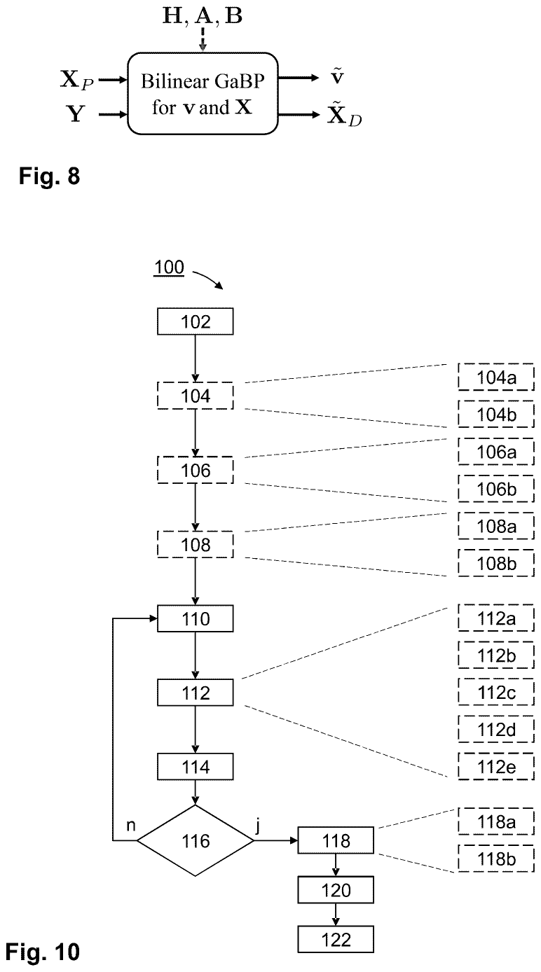

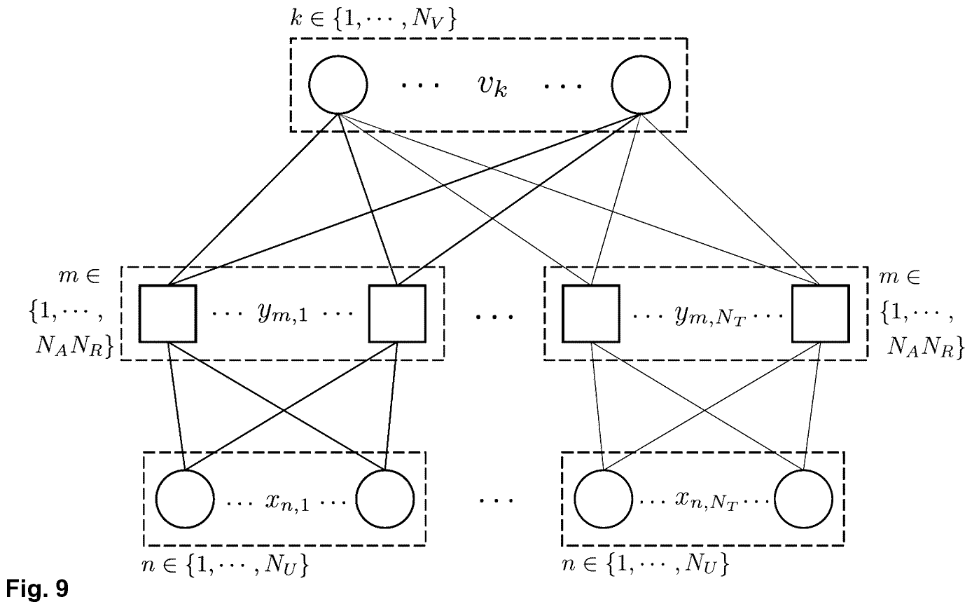

FIGS. 1 to 10 have already been described further above and will not be discussed again.

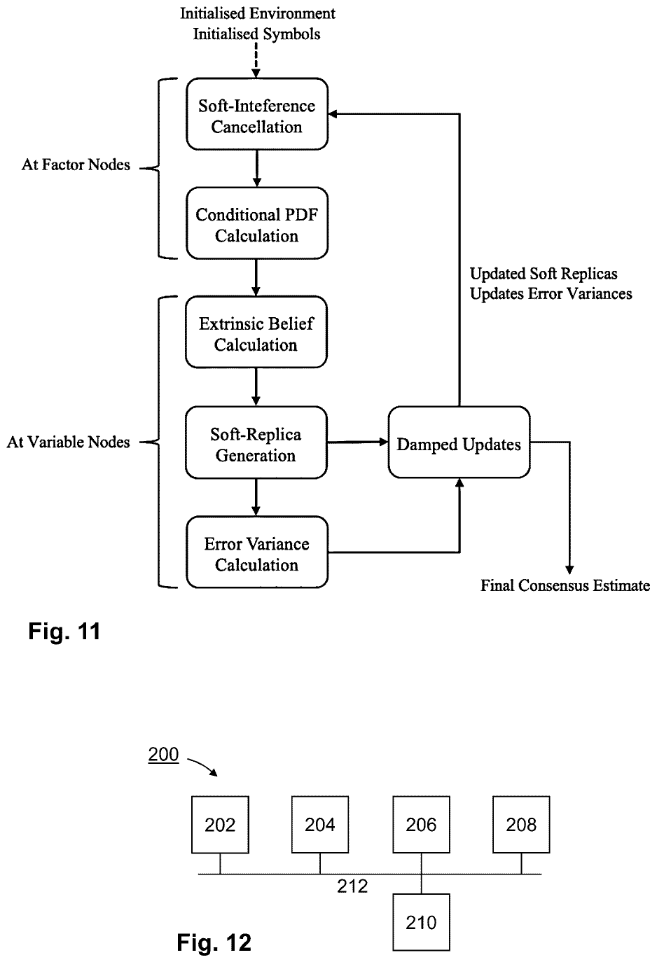

FIG. 11 shows a further exemplary schematic flow diagram of the method 100 in accordance with the invention. This flow diagram shows more abstractly described steps. After initializing the environment and the symbols, a soft interference cancellation is performed, and the conditional PDF is calculated. The previous two steps are performed at the factor nodes. Next, at the variable nodes, an extrinsic belief calculation is executed, based on the results of which soft replicas are generated for all voxels in the region of interest and for all transmit symbols. Also, an error variance is calculated for the soft-replicas. The previously generated soft-replicas and the corresponding error variances are provided to a process for updating via damping. The updated soft-replicas and error variances are then iteratively fed back to the soft interference cancellation. After a termination criterion is met, the final updates obtained via damping represent the final consensus estimate.

FIG. 12 shows an exemplary block diagram of a receiver 200 in accordance with the third aspect of the invention. The receiver 200 comprises at least one antenna 202, circuitry 204 for processing radio frequency signals, a microprocessor 206, a volatile memory 508, and a non-volatile memory 510. The aforementioned elements are communicatively connected via at least one signal or data connection or bus 212. The non-volatile memory 210 stores computer program instructions which, when executed by the microprocessor 206, cause the receiver 200 to implement or execute the method according to one or more embodiments of the first aspect of the present invention as presented above.

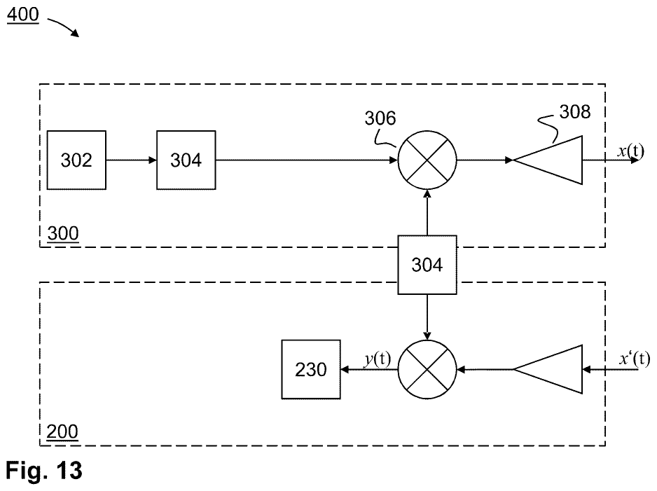

FIG. 13 shows an exemplary and schematic diagram of a communication system 400 in accordance with the invention. The communication system 400 comprises a receiver 200 and a transmitter 300. The transmitter 300 comprises a protocol machine 302, which may output a bit-sequence according to the protocol used in the communication system 400. Radio frequency (RF) related component 304 may perform tasks like pulse shaping the output of protocol machine 302. A first mixer 306 may mix the output of RF related component 304 with a signal from a high-frequency oscillator 310. The transmitter 300 may send, via output stage 308, a sent communication signal x. The output stage 308 may comprise an antenna, e.g., a rod antenna, a dipole antenna, a horn antenna, and/or a set of antennas forming a MIMO antenna.

Communication signals x′, received directly from a transmitter or reflected off an object in the region of interest prior to being received, may be received by an input stage 220 of the receiver 200. The input stage 220 may comprise a low noise amplifier (LNA). A second mixer 222 may provide an intermediate frequency (IF) signal y(t) at an output. In the example of FIG. 13, the second mixer 222 uses the same oscillator 310 signal as the transmitter 300; this variation may be useful, particularly in cases when the transmitter 300 and the receiver 200 are co-located, e.g., located in the same region of a car, in the same housing, and/or in the same component, e.g., board or chip. The resulting downmixed signal y(t) may be subjected to the process in accordance with the first aspect of the invention, represented by box 230. Box 230 may comprise, use, or be implemented by various elements or components of the receiver described with reference to FIG. 12.

List of Reference Numerals (Part of the Description)

| | |
|---|---|
| 100 | method |
| 102 | receive transmission frames |
| 104 | initialize pilot block variable |
| | nodes |
| 104a | initialize soft-replicas as |
| | pilots |
| 104b | initialize MSE |
| 106 | initialize data block variable |
| | nodes |
| 106a | initialize soft-replicas |
| 106b | initialize MSE |
| 108 | initialize environment |
| 108a | initialize environment soft- |
| | replicas |
| 108b | initialize MSE |
| 110 | perform soft interference |
| | cancellation |
| 112 | determine soft-replicas and |
| | MSE |
| 112a | compute conditional |
| | variances |
| 112b | compute environment |
| | extrinsic mean and variance |
| 112c | compute signal extrinsic |
| | mean and variance |
| 112d | compute new soft replicas |
| 112e | compute new MSE |
| 114 | update soft-replicas and MSE |
| 116 | termination criterion met? |
| 118 | compute final soft estimate |
| 118a | compute consensus PDF |
| 118b | compute conditional variance |
| 120 | project final soft estimate to |
| | symbol constellation |
| 122 | output projected transmit |
| | symbol |
| 200 | receiver |
| 202 | antenna |
| 204 | RF circuitry |
| 206 | microprocessor |
| 208 | volatile memory |
| 210 | non-volatile memory |
| 212 | data/signal lines/buses |
| 220 | input stage |
| 222 | mixer |
| 230 | process |
| 300 | transmitter |
| 302 | protocol machine |
| 304 | RF components |
| 306 | mixer |
| 308 | output stage |
| 310 | oscillator |
| 400 | communication system |
| x(t) | output signal |
| x′(t) | input signal |
| y(t) | downmixed signal |
| AP | access point |
| UE | user equipmen |

1. A method of processing wireless communication signals for use in joint communication and environment perception in a region of interest comprising N_{A}≥1 access points and N_{U}≥1 UEs, each of the N_{A} access points having N_{R}≥1 antennas, the region of interest represented by voxels arranged in a three-dimensional grid, comprising:
a) receiving, at the N_{R} antennas respectively associated with the N_{A} access points, N_{T}≥1 transmission instances, the N_{T} transmission instances carrying a plurality of transmit symbols comprising pilot signals and data signals, sent by all of the N_{U} UEs,
b) performing, for each of the N_{R} antennas of each of the N_{A} access points, a soft interference cancellation to received communication signals representing the transmit symbols, for all voxels in the region of interest and for all transmit symbols,
c) determining, for each of the N_{R} antennas of each of the N_{A} access points, soft-replicas and corresponding MSEs for all voxels in the region of interest and for all transmit symbols,
d) updating all soft-replicas and corresponding MSEs,
e) repeating steps b) to d) while a termination criterion is not met,
f) computing, for each voxel in the region of interest, and for each transmit symbol, from the corresponding soft-replicas of each of the N_{R} antennas of each of the N_{A} access points, a respective final soft-estimate,
g) projecting the final soft estimate for each transmit symbol to the symbol constellation X, and
h) outputting the projected transmit symbol as hard estimate.

2. The methodg of claim 1, further comprising,
for all as yet unknown transmit symbols, and for each of the N_{R} antennas and each of the N_{U} UEs:
initialize the soft-replicas, and/or the MSEs,
and/or
for all voxels in the region of interest and for each of the N_{R} antennas:
initialize the soft-replicas, and/or the MSEs,
prior to step b).

3. The method of claim 2, wherein,
initializing the soft-replicas for all as yet unknown transmit symbols corresponding to a pilot block comprises:
initializing the soft-replicas of the transmit signal as pilots, and/or
initializing the corresponding MSEs to 0,
and/or wherein
initializing the soft-replicas for all as yet unknown transmit symbols corresponding to a data block comprises:
initializing the soft-replicas of the transmit signal to respective values in accordance with expectations based on a known prior probability distribution of the symbol constellation, or set, and/or
initializing the corresponding MSEs to the value of the expected error of the previously initialized soft replica,
and/or wherein
initializing the soft-replicas for all voxels in the region of interest comprises:
initializing the environment soft-replicas to respective values in accordance with an expectation of a known prior probability distribution of the voxel coefficients, and/or
initializing the corresponding MSEs to the value of the expected error of the previously initialized environment soft replica.

4. The method of claim 1, wherein determining, for each of the N_{R} antennas of each of the N_{A} access points, soft-replicas and corresponding MSEs, for all voxels in the region of interest and for all transmit symbols, comprises:
computing the conditional variances
$${v}_{k : m , t}^{v} and {v}_{n , t : m , t}^{x} ,$$
computing the extrinsic mean
$${μ}_{k : m , t}^{v}$$
and variance
$${ψ}_{k : m , t}^{v} ,$$
computing the extrinsic mean
$${μ}_{n , t : m , t}^{x}$$
and variance
$${ψ}_{n , t : m , t}^{x} ,$$
computing the new soft-replicas \hat{v}_{k:m,t} and \hat{x}_{n,t:m,t}, and
computing the new
$$M S E s {ψ}_{k : m , t}^{v} and {ψ}_{m , t : n , t}^{x} .$$

5. The method of claim 1, wherein step f) comprises:
computing the consensus PDFs using
$${\tilde{μ}}_{k}^{v} , {\tilde{μ}}_{n , t}^{x} , {\tilde{ψ}}_{k}^{v} and {\tilde{ψ}}_{n , t}^{x} ,$$
and
computing the conditional variances
$${v}_{k : m , t}^{v} and {v}_{n , t : m , t}^{x} .$$

6. The method of claim 1 wherein a wireless communication signal carrying the transmit symbols uses transmission frames having data symbols and pilot symbols, the pilot symbols being known at the receiver.

7. The method of claim 6, wherein the frequency of the wireless communication signal is within a radar frequency range, including a frequency range between 30 GHz and 300 GHz, particularly between 50 and 150 GHz, for instance between 57 GHz and 71 GHz.

8. A non-transitory computer-readable medium, having stored thereon computer-executable instructions, which, when executed by a processor of or functionally coupled with a receiver, cause the processor and/or the receiver to process wireless communication signals for use in joint communication and environment perception in a region of interest comprising N_{A}≥1 access points and N_{U}≥1 UEs, each of the N_{A} access points having N_{R}≥1 antennas, the region of interest represented by voxels arranged in a three-dimensional grid, by performing operations comprising:
a) receiving, at the NAR antennas respectively associated with the N_{A} access points, N_{T}≥1 transmission instances, the N_{T} transmission instances carrying a plurality of transmit symbols comprising pilot signals and data signals, sent by all of the N_{U} UEs,
b) performing, for each of the N_{R} antennas of each of the N_{A} access points, a soft interference cancellation to received communication signals representing the transmit symbols, for all voxels in the region of interest and for all transmit symbols,
c) determining, for each of the N_{R} antennas of each of the N_{A} access points, soft-replicas and corresponding MSEs for all voxels in the region of interest and for all transmit symbols,
d) updating all soft-replicas and corresponding MSEs,
e) repeating steps b) to d) while a termination criterion is not met,
f) computing, for each voxel in the region of interest, and for each transmit symbol, from the corresponding soft-replicas of each of the N_{R} antennas of each of the N_{A} access points, a respective final soft-estimate,
g) projecting the final soft estimate for each transmit symbol to the symbol constellation X, and
h) outputting the projected transmit symbol as hard estimate.

9. (canceled)

10. A receiver for wireless communication signals comprising at least one antenna, circuitry for processing radio frequency signals, a microprocessor, volatile and non-volatile memory, connected via one or more data and/or signal lines or buses, wherein the non-volatile memory stores computer program instructions which, when executed by the microprocessor, configure components of the receiver to process wireless communication signals for use in joint communication and environment perception in a region of interest comprising N_{A}≥1 access points and N_{U}≥1 UEs, each of the N_{A} access points having N_{R}≥1 antennas, the region of interest represented by voxels arranged in a three-dimensional grid, by performing operations comprising:
a) receiving, at the N_{R} antennas respectively associated with the N_{A} access points, N_{T}≥1 transmission instances, the N_{T} transmission instances carrying a plurality of transmit symbols comprising pilot signals and data signals, sent by all of the N_{U} UEs,
b) performing, for each of the N_{R} antennas of each of the N_{A} access points, a soft interference cancellation to received communication signals representing the transmit symbols, for all voxels in the region of interest and for all transmit symbols,
c) determining, for each of the N_{R} antennas of each of the N_{A} access points, soft-replicas and corresponding MSEs for all voxels in the region of interest and for all transmit symbols,
d) updating all soft-replicas and corresponding MSEs,
e) repeating steps b) to d) while a termination criterion is not met,
f) computing, for each voxel in the region of interest, and for each transmit symbol, from the corresponding soft-replicas of each of the N_{R} antennas of each of the N_{A} access points, a respective final soft-estimate,
g) protecting the final soft estimate for each transmit symbol to the symbol constellation X, and
h) outputting the projected transmit symbol as hard estimate.

11. The receiver of claim 10, wherein the receiver is co-located to a transmitter configured for sending communication signals.

12. The receiver of claim 10, wherein the circuitry for processing radio frequency signals comprises a low noise amplifier and/or a mixer configured for providing a representation of a received signal at an intermediate frequency, preferably using a same oscillator signal as a co-located transmitter.

13. A communication system comprising a receiver and a corresponding transmitter configured for sending a communication signal, the receiver being configured to process wireless communication signals for use in joint communication and environment perception in a region of interest comprising N_{A}≥1 access points and N_{U}≥1 UEs, each of the N_{A} access points having N_{R}≥1 antennas, the region of interest represented by voxels arranged in a three-dimensional grid, by performing operations comprising:
a) receiving, at the NAR antennas respectively associated with the N_{A} access points,
N_{T}≥1 transmission instances, the N_{T} transmission instances carrying a plurality of transmit symbols comprising pilot signals and data signals, sent by all of the N_{U} UEs,
b) performing, for each of the N_{R} antennas of each of the N_{A} access points, a soft interference cancellation to received communication signals representing the transmit symbols, for all voxels in the region of interest and for all transmit symbols,
c) determining, for each of the N_{R} antennas of each of the N_{A} access points, soft-replicas and corresponding MSEs for all voxels in the region of interest and for all transmit symbols,
d) updating all soft-replicas and corresponding MSEs,
e) repeating steps b) to d) while a termination criterion is not met,
f) computing, for each voxel in the region of interest, and for each transmit symbol, from the corresponding soft-replicas of each of the N_{R} antennas of each of the N_{A} access points, a respective final soft-estimate,
g) protecting the final soft estimate for each transmit symbol to the symbol constellation X, and
h) outputting the projected transmit symbol as hard estimate.

14. A vehicle comprising a receiver and/or a communication system, the receiver being configured to process wireless communication signals for use in joint communication and environment perception in a region of interest comprising N_{A}≥1 access points and N_{U}≥1 UEs, each of the N_{A} access points having N_{R}≥1 antennas, the region of interest represented by voxels arranged in a three-dimensional grid, by performing operators comprising:
a) receiving, at the N_{R} antennas respectively associated with the N_{A} access points, N_{T}≥1 transmission instances, the N_{T} transmission instances carrying a plurality of transmit symbols comprising pilot signals and data signals, sent by all of the N_{U} UEs,
b) performing, for each of the N antennas of each of the N_{A} access points, a soft interference cancellation to received communication signals representing the transmit symbols, for all voxels in the region of interest and for all transmit symbols,
c) determining, for each of the N_{R} antennas of each of the N_{A} access points, soft-replicas and corresponding MSEs for all voxels in the region of interest and for all transmit symbols,
d) updating all soft-replicas and corresponding MSEs,
e) repeating steps b) to d) while a termination criterion is not met,
f) computing, for each voxel in the region of interest, and for each transmit symbol, from the corresponding soft-replicas of each of the N_{R} antennas of each of the N_{A} access points, a respective final soft-estimate,
g) projecting the final soft estimate for each transmit symbol to the symbol constellation X, and
h) outputting the projected transmit symbol as hard estimate; and
the communication system comprising the receiver and a corresponding transmitter configured for sending a communication signal.

15. Use of a receiver and/or a communication system or of a method for both wireless communication and radar sensing the receiver being configured to process wireless communication signals for use in joint communication and environment perception in a region of interest comprising N_{A}≥1 access points and N_{U}≥1 UEs, each of the N_{A} access points having N_{R}≥1 antennas, the region of interest represented by voxels arranged in a three-dimensional grid, by performing operators comprising:
a) receiving, at the N_{R} antennas respectively associated with the N_{A} access points, N_{T}≥1 transmission instances, the N_{T} transmission instances carrying a plurality of transmit symbols comprising pilot signals and data signals, sent by all of the N_{U} UEs,
b) performing, for each of the N antennas of each of the N_{A} access points, a soft interference cancellation to received communication signals representing the transmit symbols, for all voxels in the region of interest and for all transmit symbols,
c) determining, for each of the N_{R} antennas of each of the N_{A} access points, soft-replicas and corresponding MSEs for all voxels in the region of interest and for all transmit symbols,
d) updating all soft-replicas and corresponding MSEs,
e) repeating steps b) to d) while a termination criterion is not met,
f) computing, for each voxel in the region of interest, and for each transmit symbol, from the corresponding soft-replicas of each of the N_{R} antennas of each of the N_{A} access points, a respective final soft-estimate,
g) projecting the final soft estimate for each transmit symbol to the symbol constellation X, and
h) outputting the projected transmit symbol as hard estimate; and
the communication system comprising the receiver and a corresponding transmitter configured for sending a communication signal;
the communication system comprising the receiver and a corresponding transmitter configured for sending a communication signal; and
wherein the method for both wireless communication and radar sensing comprises: A method of processing wireless communication signals for use in joint communication and environment perception in a region of interest comprising N_{A}≥1 access points and N_{U}≥1 UEs, each of the N_{A} access points having N_{R}≥1 antennas, the region of interest represented by voxels arranged in a three-dimensional grid, comprising:
a′) receiving, at the N_{R} antennas respectively associated with the N_{A} access points, N_{T}≥1 transmission instances, the N_{T} transmission instances carrying a plurality of transmit symbols comprising pilot signals and data signals, sent by all of the N_{U} UEs,
b′) performing, for each of the N_{R} antennas of each of the N_{A} access points, a soft interference cancellation to received communication signals representing the transmit symbols, for all voxels in the region of interest and for all transmit symbols,
c′) determining, for each of the N_{R} antennas of each of the N_{A} access points, soft-replicas and corresponding MSEs for all voxels in the region of interest and for all transmit symbols,
d′) updating all soft-replicas and corresponding MSEs,
e′) repeating steps b) to d) while a termination criterion is not met,
f′) computing, for each voxel in the region of interest, and for each transmit symbol, from the corresponding soft-replicas of each of the N_{R} antennas of each of the N_{A} access points, a respective final soft-estimate,
g′) projecting the final soft estimate for each transmit symbol to the symbol constellation X, and
h′) outputting the projected transmit symbol as hard estimate.
